(19) United States
(12) Patent Application Publication
(10) Pub. No.: US 2015/0120537 A1
(43) Pub. Date: Apr. 30, 2015

(54) Method for Facilitating Loans

(71) Applicants: Russell Chacon, Scotts Valley, CA (US); LeRoy Harold Pint, Magnolia, TX (US)

(72) Inventors: Russell Chacon, Scotts Valley, CA (US); LeRoy Harold Pint, Magnolia, TX (US)

(21) Appl. No.: 14/524,398

(22) Filed: Oct. 27, 2014

Related U.S. Application Data
(60) Provisional application No. 61/895,898, filed on Oct. 25, 2013.

(51) Int. Cl. G06Q 20/24; G06Q 20/10

(52) U.S. Cl. CPC G06Q 20/24; G06Q 20/102
USPC 705/40

(57) ABSTRACT

A system and method for facilitating loans for consumers, wherein a payments account and a loans account for a user are linked together. Both the payments account and the loans account have a balance, wherein the balance of the payments account can be used to withdraw funds, pay bills, etc., and the balance of the loans account keeps a record of all money owed to a lender. Money can be deposited into the payments account through a personal bank account, an intermediary service account, a funding account, or from a reload source. Loans can be paid off through a lenders account, wherein a loan payment value is transferred from the balance of the payments account to the balance of the lenders account. The payments account is operated in a foreign banking infrastructure, while the lenders account can either be in a foreign or domestic banking infrastructure.

The current application claims a priority to the U.S. Provisional Patent application Ser. No. 61/895,012 filed on Oct. 25, 2013. The current application is filed on Oct. 27, 2014 while Oct. 25, 2014 was on a weekend.

### FIELD OF THE INVENTION

The present invention relates generally to a method and system for loans. More specifically, the present invention is a method and system for facilitating loans for consumers by linking two accounts together and utilizing one or more foreign banking entities.

### BACKGROUND OF THE INVENTION

Millions of people are involved with loans throughout the world. While many current methods exist, new methods can bring broader availability, increased functionality, and lower costs to consumers. It is therefore an object of the present invention to introduce a method and system for facilitating loans with an attached payments account for consumers by linking two accounts together and utilizing one or more foreign banking entities. The two linked accounts being the payments account and a loans account. The utilization of international money networks and domestic or foreign domiciled accounts offers more functionality in the processing and use of funds than compared to currently available options. Additionally, the use of international money networks and domestic or foreign domiciled accounts facilitates lower costs for consumers than alternative solutions, and allows for the maintenance of higher levels of consumer protection.

### BRIEF DESCRIPTION OF THE DRAWINGS

FIG. 1 is a flowchart of the method of the present invention;

FIG. 2 is a flowchart thereof, further detailing the step for receiving an initial deposit value from a funding account;

FIG. 3 is a flowchart thereof, further describing the steps for using the balance of the payments account to pay a bill;

FIG. 4 is a flowchart thereof, further depicting the steps for withdrawing money from the payments account through a personal bank account;

FIG. 5 is a flowchart thereof, further depicting the steps for withdrawing money from the payments account through an intermediary service account;

FIG. 6 is a flowchart thereof, further depicting the steps for processing an aggregate deposit;

FIG. 7 is a flowchart thereof, further depicting the step for receiving a subsequent deposit from various sources; and

FIG. 8 is a flowchart thereof, further depicting the steps for receiving the subsequent deposit from a funding account.

FIG. 9 is a diagram illustrating the flow of funds for opening a payments account.

FIG. 10 is a diagram illustrating the flow of day-to-day deposits, withdrawals and payments.

FIG. 11 is a diagram illustrating the flow of payments for paying off a loan.

FIG. 12 is a diagram illustrating the flow of funds through an optional intermediary service account or banking institution.

FIG. 13 is a diagram wherein the lenders account is in a different banking infrastructure than the payments account.

FIG. 14 is a diagram wherein the lenders account is in a domestic banking infrastructure and the payments account is in a foreign banking infrastructure.

FIG. 15 is a diagram illustrating the opening of a payments account and a loans account through a money service agent.

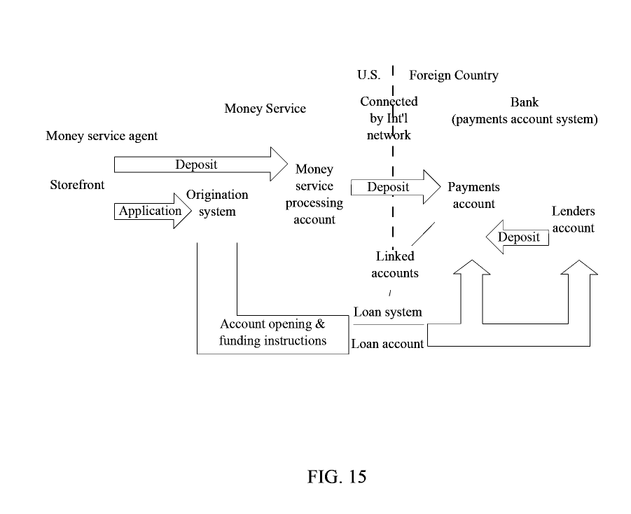

FIG. 16 is a diagram illustrating a bill pay request being processed through the intermediary service account for the money service agent.

FIG. 17 is a diagram illustrating the flow of deposited funds through the intermediary service account.

### DETAIL DESCRIPTIONS OF THE INVENTION

All illustrations of the drawings are for the purpose of describing selected versions of the present invention and are not intended to limit the scope of the present invention.

The present invention is a system and method for facilitating loans for consumers by linking two accounts together and utilizing one or more foreign banking entities. The two linked accounts consist of a loan account and a payments account that are held by the consumer; the payments account facilitating money transactions such as deposits and withdraws, and the loans account documenting all loan transactions. The payments account is operated through a payments account system, while the loans account is operated through a loans system. The loans account is able to facilitate any type of loan structure, such as balloon payment loans, installment loans, a line of credit, payday loans, or deposit advances.

The payments account can be any account that facilitates funds in and enables cash/payments out, including but not limited to a stored-value account, prepaid debit account, checking account, electronic-only checking account, savings account, money market account, virtual debit card account, virtual credit card account, credit card account or line of credit. The payments account is held in a foreign banking infrastructure. The foreign banking infrastructure can be any financial service entity licensed in a foreign country as a domestic or offshore bank, other foreign entities that are legally authorized to provide financial services to domestic consumers directly or indirectly, and other sovereign entities that are legally authorized to provide financial services to domestic consumers directly or indirectly.

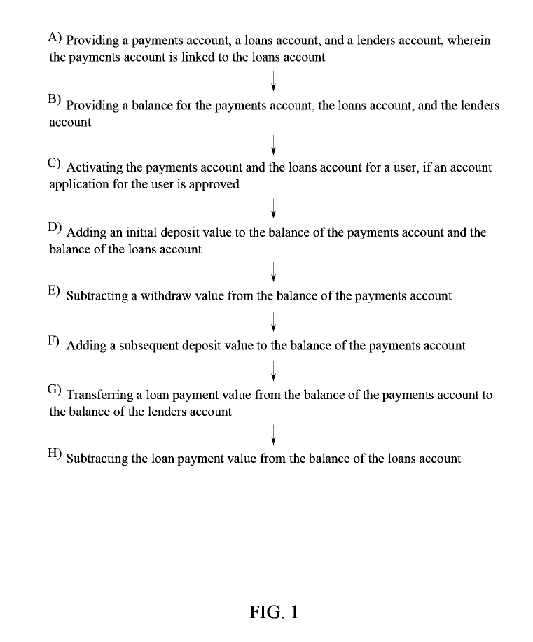

In reference to FIG. 1, a user first submits an account application into the system of the present invention. If the account application for the user is approved, then the payments account is activated for the user. If the user would like to take out a loan, then the loans account is also activated for the user. Initial funds can be transferred into the payments account in one of two ways; either through a deposit or a loan. The initial funds can be deposited into the payments account in several ways, including but not limited to a face-to-face deposit, deposit through a mobile device, or an electronic transfer from a personal bank account or an intermediary service account, such as a wire transfer or Automated Clearing House (ACH) transaction. If the loans account is activated and the user is approved for a loan, then the initial funds can be placed into the payments account in the form of a loan advance.

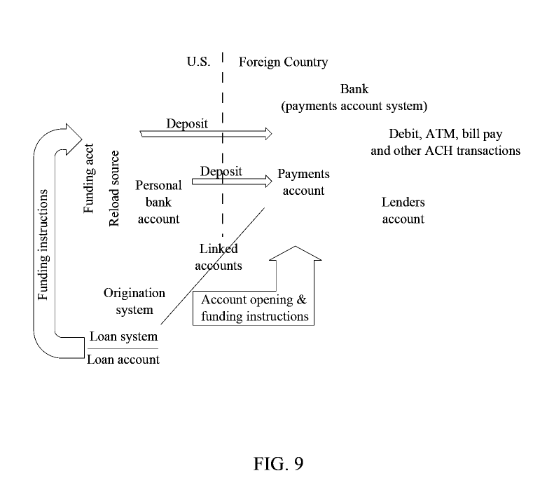

The loan advance comes from a lender who elects to lend money to the user. The lender has a funding account from which the loan advance is transferred into the payments account. The funding account can be operated either within a foreign banking infrastructure or a domestic banking infrastructure. When the user is approved for the loan, funding instructions are sent to the funding account dictating the amount of funds that should be transferred to the payments account. In reference to FIG. 9, the payments account and the loans account are linked to each other, such that when money is deposited into the payments account from the funding account, a record of the funds transferred is kept in the loans account in order to keep track of funds owed to the lender. The payments account and the loans account are linked by notations in the payments account system, the loans system, a separate computer system, or any combination thereof.

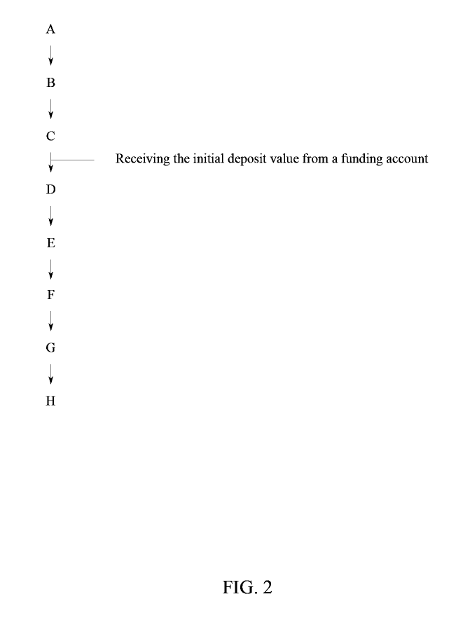

In reference to FIG. 1, both the payments account and the loans account carry a balance to record money transactions. The balance for the payments account records the active amount of money that is available to the user to spend, while the balance for the loans account records the money owed by the user to a lender. When the initial funds are deposited, an initial deposit value is added to the balance of the payments account to show the available funds from the initial deposit. If the initial funds are a loan advance, then the payments account system receives the initial deposit value from the funding account, as shown in FIG. 2, wherein the initial deposit value is added to the balance of the payments account. Additionally, the initial deposit value is added to the balance of the loans account, indicating that the user is indebted for the value of the loan advance.

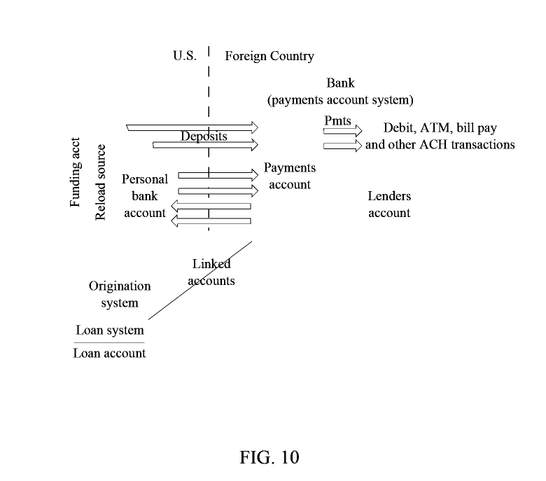

In reference to FIG. 10, once the initial deposit has been made in the payments account, the user can then use the funds for any purpose. The balance of the payments account can be spent or withdrawn using a variety of potential methods, depending on the specific features of the payment account. These methods include, but are not limited to, using a debit/credit/charge card, automated teller machine (ATM), bill payment feature, or cash advances available at banks, money service agents or channel partners. In reference to FIG. 1, when funds are withdrawn from the payments account, a withdraw value is subtracted from the balance of the payments account in the amount of the desired funds.

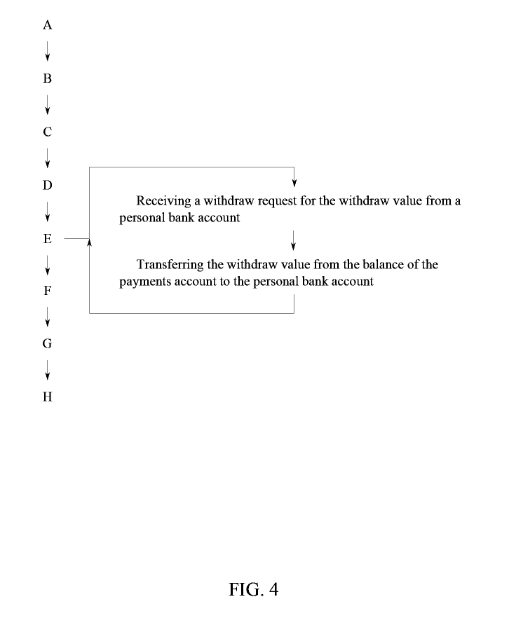

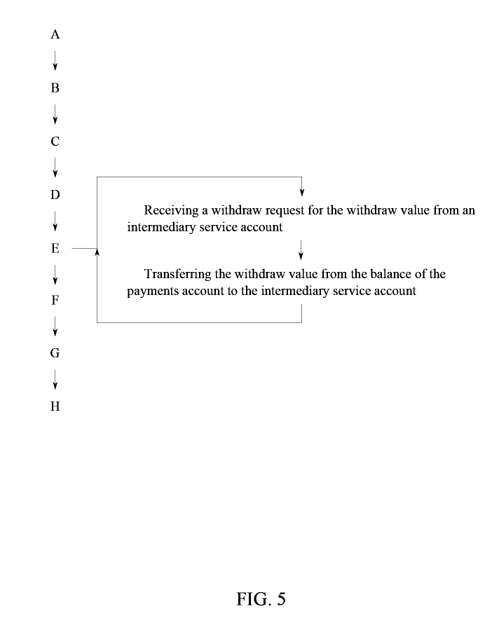

In reference to FIG. 4, when money is withdrawn through another bank, the payments account system receives a withdraw request for the withdraw value from the personal bank account of the user. The withdraw value is then transferred from the balance of the payments account to the personal bank account, wherein the bank provides a cash advance of the funds. Similarly and in reference to FIG. 5, when money is withdrawn through a money service agent, the payments account system receives the withdraw request for the withdraw value from the intermediary service account of the money service agent. The withdraw value is then transferred from the balance of the payments account to the intermediary service account, wherein the money service agent provides a cash advance of the funds.

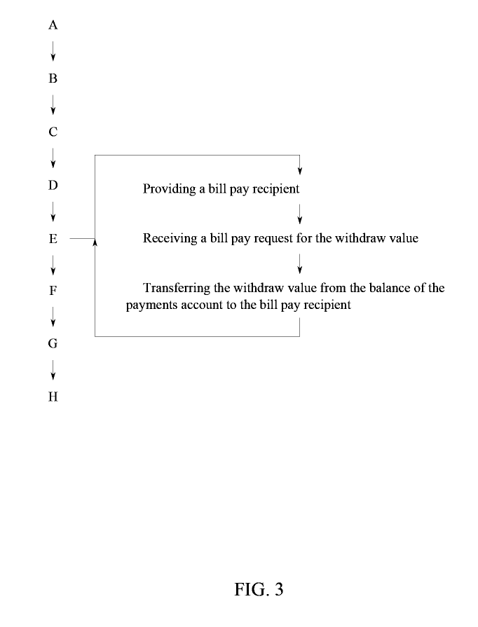

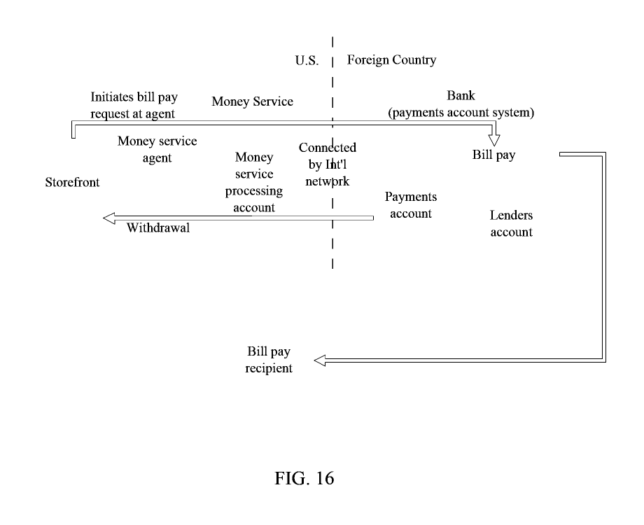

In reference to FIG. 3 and FIG. 16, when using the bill pay feature to transfer funds to a bill pay recipient, the payments account system receives a bill pay request for the withdraw value. The withdraw value is then transferred from the balance of the payments account to the bill pay recipient. The bill pay request can be submitted to the payments account system through the intermediary service account of the user's choosing, the personal bank account of the user, through a mobile device, via a face-to-face confrontation, or by any other means.

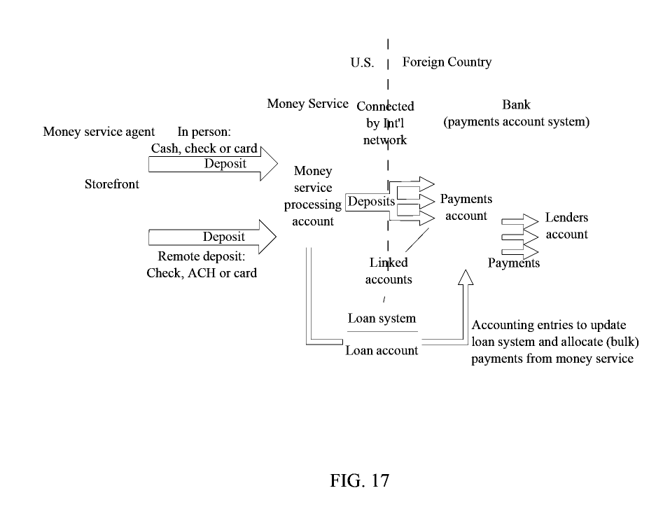

In reference to FIG. 17, the user can also add additional funds to the payments account at anytime. Deposits can be direct deposit of paychecks and/or electronic transfers (including, but not limited to ACH, wire, or internal transfers) from other accounts, such as the personal bank account of the user or the intermediary service account of the money service agent. These can be one-time or recurring payments originated by the customer, or auto-originated to collect funds for a loan payment on a linked loan. In reference to FIG. 1, when additional funds are deposited into the payments account, a subsequent deposit value is added to the balance of the payments account in the amount of the additional funds.

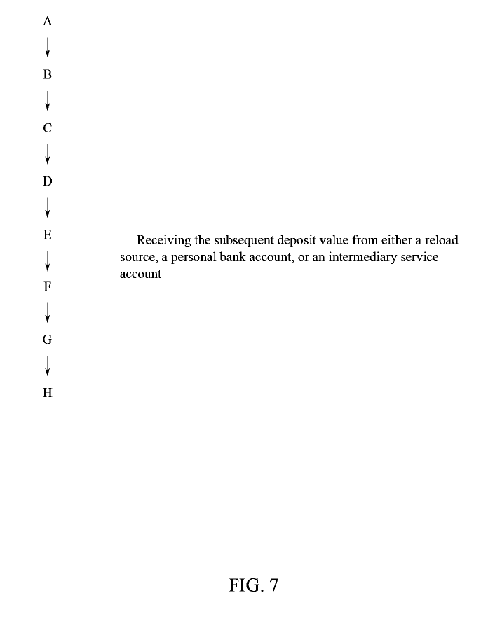

In reference to FIG. 7, when money is deposited through the personal bank account of the user, the payments account system receives the subsequent deposit value from the personal bank account through the bank's system. Similarly, when money is deposited through the intermediary service account of the money service agent, the payments account system receives the subsequent deposit value from the intermediary service account through the money agent's system. Money can also be deposited through a reload source, such as an ATM, wherein the payments account system receives the subsequent deposit value directly from the reload source.

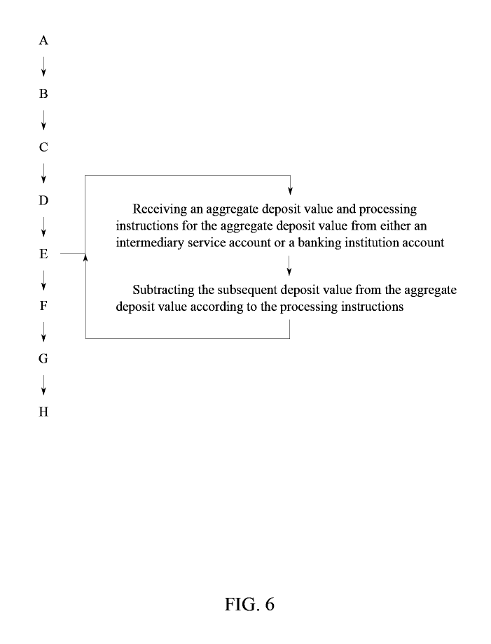

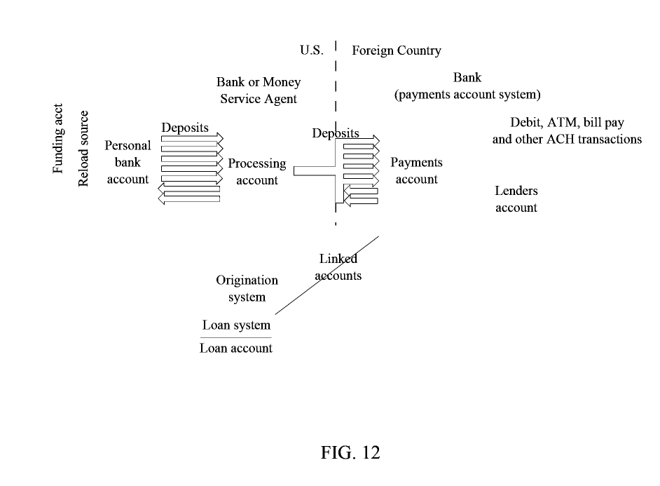

In reference to FIG. 6 and FIG. 12, the payments account system is also capable of receiving an aggregate deposit value, wherein the aggregate deposit value is a total sum of money deposited by multiple entities through either a money service agent or banking institution. The aggregate deposit value is received from either the intermediary service account of the money service agent or a banking institution account for the banking institution, wherein the banking institution account is a mass account for the personal bank account of each user of the banking institution. In addition to the aggregate deposit value, the payments account system receives processing instructions for distributing the funds allocated by the aggregate deposit value. The payments account system then subtracts the subsequent deposit value for the payments account of the user from the aggregate deposit value according to the processing instructions.

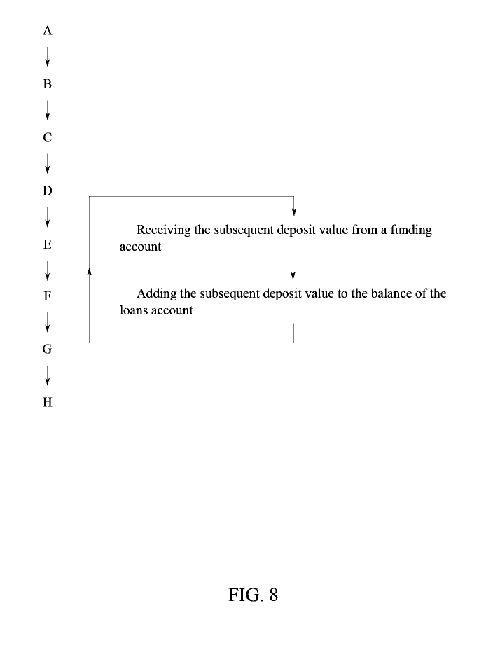

In reference to FIG. 8, it is also possible for additional funds to be placed in the payments account in the form of a subsequent loan. The subsequent loan can be a second loan from the lender who originally loaned money, or from a secondary lender. In such a case, the payments account system receives the subsequent deposit value from the funding account of the lender or secondary lender. The subsequent deposit value is then added to the balance of the loans account, as well as the payments account, in order to document the money owed to the lender or the secondary lender.

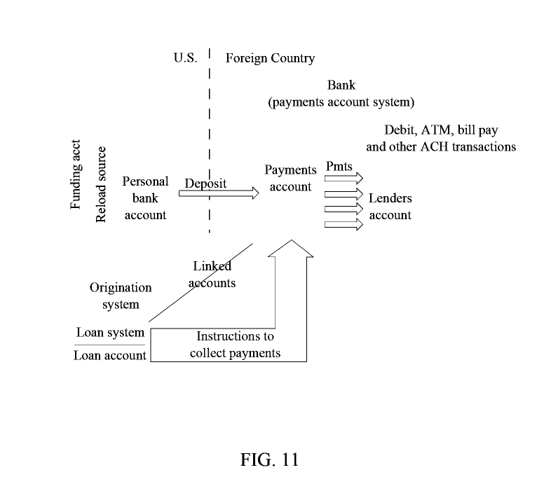

In reference to FIG. 1 and FIG. 11, in order to pay off a loan, money is transferred from the payments account of the user to a lenders account, wherein the lenders account is a deposit account for the lender who gave out the loan. Similar to the payments account and the loans account, the lenders account has a balance. When a loan payment is made, a loan payment value is transferred from the balance of the payments account to the balance of the lenders account. Additionally, the loan payment value is subtracted from the balance of the loans account in order to record that a portion of the loan has been paid off.

It is possible for loan payments to be scheduled within either the payments account system or the loans system. Loan payment instructions are either retained in the payments account system, or sent to the payments account system from the loans system. The transfer of the loan payment value from the payments account to the lenders account is then transacted according to the scheduling of the loan payment instructions. If the payments account does not have sufficient funds for a scheduled transfer into the lenders account, then an electronic transfer may be generated to collect funds from the personal bank account of the user, or another external bank account.

The payments account system can also be configured such that when a deposit is made into the payments account, the deposit is automatically transferred into the lenders account. When the subsequent deposit value for the deposit is received by the payments account system, the subsequent deposit value is automatically transferred to the balance of the lenders account, while simultaneously being subtracted from the balance of the loans account. It is also possible for the automatic transfer of funds to the lenders account to be declared by the banking institution or the money service agent when the user makes a deposit.

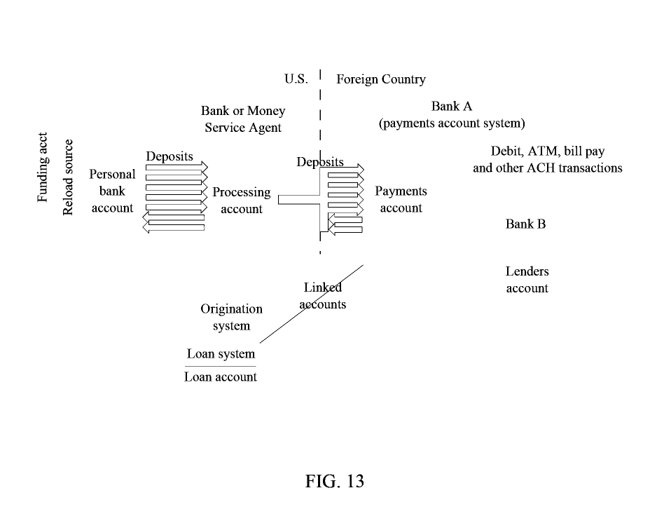

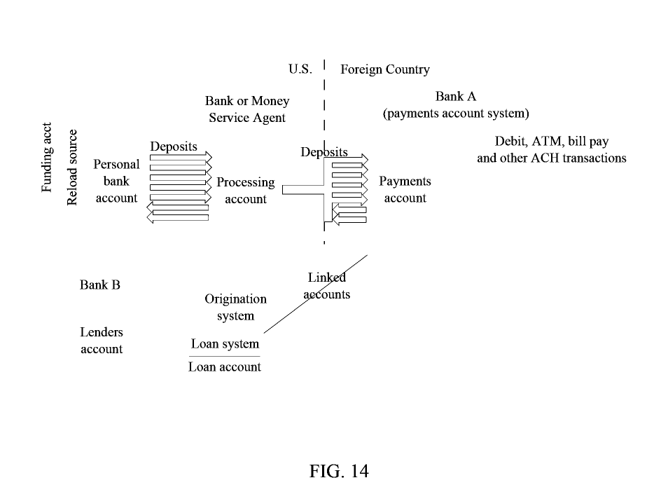

In the preferred embodiment of the present invention, the payments account and the lenders account are operated within the same banking infrastructure, wherein the banking infrastructure is a foreign banking structure, as depicted in FIG. 9. However, it is also possible for other variations to exist. For example, the payments account and the lenders account can be operated within different banking infrastructures, wherein both the payments account and the lenders account are in a foreign banking infrastructure, as depicted in FIG. 13. As another example, the payments account and the lenders account can be operated within different banking infrastructures, wherein the payments account is in a foreign banking infrastructure and the lenders account is in a domestic banking infrastructure, as depicted in FIG. 14.

Although the invention has been explained in relation to its preferred embodiment, it is to be understood that many other possible modifications and variations can be made without departing from the spirit and scope of the invention as hereinafter claimed.

What is claimed is:

1. A method for facilitating loans by executing computer-executable instructions stored on a non-transitory computer-readable medium, the method comprises the steps of:
providing a payments account, a loans account, and a lenders account, wherein the payments account is linked to the loans account;
providing a balance for the payments account, the loans account, and the lenders account;
activating the payments account and the loans account for a user,
if an account application for the user is approved;
adding an initial deposit value to the balance of the payments account and the balance of the loans account;
subtracting a withdraw value from the balance of the payments account;
adding a subsequent deposit value to the balance of the payments account;
transferring a loan payment value from the balance of the payments account to the balance of the lenders account; and
subtracting the loan payment value from the balance of the loans account.

2. The method for facilitating loans by executing computer-executable instructions stored on a non-transitory computer-readable medium, the method as claimed in claim 1 further comprises the steps of:
receiving the initial deposit value from a funding account.

3. The method for facilitating loans by executing computer-executable instructions stored on a non-transitory computer-readable medium, the method as claimed in claim 1 further comprises the steps of:
providing a bill pay recipient;
receiving a bill pay request for the withdraw value; and
transferring the withdraw value from the balance of the payments account to the bill pay recipient.

4. The method for facilitating loans by executing computer-executable instructions stored on a non-transitory computer-readable medium, the method as claimed in claim 1 further comprises the steps of:
receiving a withdraw request for the withdraw value from a personal bank account; and
transferring the withdraw value from the balance of the payments account to the personal bank account.

5. The method for facilitating loans by executing computer-executable instructions stored on a non-transitory computer-readable medium, the method as claimed in claim 1 further comprises the steps of:
receiving a withdraw request for the withdraw value from an intermediary service account; and
transferring the withdraw value from the balance of the payments account to the intermediary service account.

6. The method for facilitating loans by executing computer-executable instructions stored on a non-transitory computer-readable medium, the method as claimed in claim 1 further comprises the steps of:
receiving an aggregate deposit value and processing instructions for the aggregate deposit value, wherein the processing instructions include the subsequent deposit value; and
subtracting the subsequent deposit value from the aggregate deposit value according to the processing instructions.

7. The method for facilitating loans by executing computer-executable instructions stored on a non-transitory computer-readable medium, the method as claimed in claim 6 further comprises the steps of:
receiving the aggregate deposit value from an intermediary service account.

8. The method for facilitating loans by executing computer-executable instructions stored on a non-transitory computer-readable medium, the method as claimed in claim 6 further comprises the steps of:
receiving the aggregate deposit value from a banking institution account.

9. The method for facilitating loans by executing computer-executable instructions stored on a non-transitory computer-readable medium, the method as claimed in claim 1 further comprises the steps of:
receiving the subsequent deposit value from a personal bank account.

10. The method for facilitating loans by executing computer-executable instructions stored on a non-transitory computer-readable medium, the method as claimed in claim 1 further comprises the steps of:
receiving the subsequent deposit value from a reload source.

11. The method for facilitating loans by executing computer-executable instructions stored on a non-transitory computer-readable medium, the method as claimed in claim 1 further comprises the steps of:
receiving the subsequent deposit value from a funding account; and
adding the subsequent deposit value to the balance for the loans account.

12. The method for facilitating loans by executing computer-executable instructions stored on a non-transitory computer-readable medium, the method as claimed in claim 1 further comprises the steps of:
receiving the subsequent deposit value from an intermediary service account.

13. The method for facilitating loans by executing computer-executable instructions stored on a non-transitory computer-readable medium, the method as claimed in claim 1, wherein the transfer of the loan payment value is scheduled according to loan payment instructions.

14. The method for facilitating loans by executing computer-executable instructions stored on a non-transitory computer-readable medium, the method as claimed in claim 1, wherein the payments account is in a foreign banking infrastructure.

15. The method for facilitating loans by executing computer-executable instructions stored on a non-transitory computer-readable medium, the method as claimed in claim 1, wherein the lenders account is in a foreign banking infrastructure.

16. The method for facilitating loans by executing computer-executable instructions stored on a non-transitory computer-readable medium, the method as claimed in claim 1, wherein the lenders account is in a domestic banking infrastructure.

17. The method for facilitating loans by executing computer-executable instructions stored on a non-transitory computer-readable medium, the method as claimed in claim 1, wherein the payments account and the lenders account are operated within the same banking infrastructure.

18. The method for facilitating loans by executing computer-executable instructions stored on a non-transitory computer-readable medium, the method as claimed in claim 1, wherein the payments account and the lenders account are operated within different banking infrastructures.
